(19) United States
(12) Patent Application Publication
(10) Pub. No.: US 2015/0294285 A1
(43) Pub. Date: Oct. 15, 2015

(54) System and Methods for Recovery of Legal Damages Across Borders

(71) Applicant: David Elmo Purinton, Orem, UT (US)

(72) Inventor: David Elmo Purinton, Orem, UT (US)

(21) Appl. No.: 14/250,593

(22) Filed: Apr. 11, 2014

(51) Int. Cl. G06Q 20/14; G06Q 30/06

(52) U.S. Cl. CPC G06Q 20/145; G06Q 30/0609; G06Q 30/0645

(57) ABSTRACT

An integrated system and method of contract creation and management geared toward aiding the rental industry in recovery of damage losses from U.S. Nationals who rent abroad.

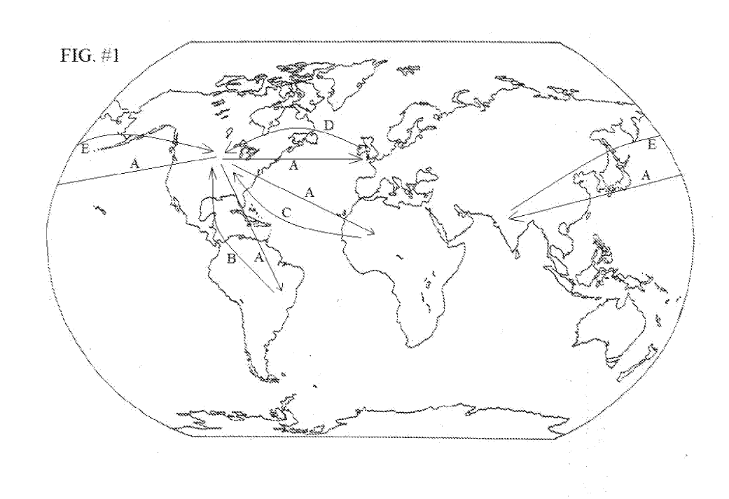

### CROSS-REFERENCE TO RELATED APPLICATIONS

This Application claims priority to Provisional Patent Application 61/811,606 filed by same inventor on Apr. 12, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Field of the invention is recovery of money damages in civil law suit situations, where conflicts of laws, forum selection, and choice of law are at issue. Resolution of damage claims in the rental business, for recovery from individuals who rent abroad, has particular nuances that require specialized systems and processes which are installed, organized, and performed in particular sequences, so that damage claimants may be able to reach reasonable fair and just resolution for recovery of damages from the tortfeasors (Respondents) who are United States Citizens, upon their return to the United States. Historically, rental companies would have to obtain payment for damages from the renter prior to them leaving the country where rented. Collection actions have been pursued, but may have resulted in dead end recovery paths because there was no jurisdiction in the country where the damage occurrence took place. Forum and choice of law clauses, assigning jurisdiction or venue to courts or alternative dispute resolution forums such as mediation or arbitration, have been used extensively and often found enforceable by United States Courts of jurisdiction. e.g. Bremen v. Zapata Off-Shore Co., 407 U.S. 1 (1972).

### BRIEF SUMMARY OF THE INVENTION

A person (individual or corporate entity, hereafter “Claims Administrator”) in the United States enters into an assignment agreement (“Administrative Assignment”) with a rental agency in a foreign country (hereafter “Rental Agent”) whereby the Rental Agent agrees to have said Claims Administrator handle recovery of damage claims for rented vehicles, equipment, or other rental goods, products, or commodities (“Rental”) if and when the Rental is damaged while in the custody and control of a United States Citizen (hereafter “Citizen”) while renting in the foreign country.

When said Citizen travels to a foreign country and reserves or otherwise requests said Rental, the Rental Agent requires the Citizen to sign an additional agreement (“Addendum”) which through binding agreement contains language (‘hereafter “Clause”) which assigns all claims (“Claims Assignment”) for damages, occurring during said Rental, to said Claims Administrator.

Citizen is asked to declare, at time of Rental, Citizen's home state (“State”) of residence along with address, phone number, and any other identifying information which will aid in contacting said Citizen in the United States. Proof of identification such as Driver's License, Credit Card, Bank Account, or other proof can be obtained from Citizen by Rental Agent.

Said Clause is generated based on said Citizen Declaration and a forum choice, choice of law, and assignment of claims is made by Citizen through expressed agreement, which in a preferred embodiment, chooses the Citizen's home state as the forum and choice of law for administration or litigation of any damages or recovery of costs for any damage.

Said Clause Rental Agent's standard terms and conditions of Rental are generated based on Rental Agent's contract with said Citizen and then added (or incorporated by reference) into said Addendum. In the event of damage to said Rental, when said damage is reported or discovered, Rental Agent attempts to notify (or otherwise remind) said Citizen of the terms of the Addendum. After said damage is reported or discovered, Rental Agent attempts to notify (or otherwise report) said damage to said Claims Administrator in the United States.

Claims Administrator in the United States may then send notification to Citizen at the mailing address obtained during the reservation or Rental. Upon Citizen's return to the United States Claims Administrator may continue to contact Citizen by any means of communication available or prudent to attempt to settle the damage claim.

If damage claim is disputed by Citizen, Claims Administrator may utilize any and all non-judicial actions and remedies as allowed in the State of residence. If non-judicial actions and remedies do not result in recovery to the Claims Administrator's or Rental Agents satisfaction, Claims Administrator may resort to judicial action.

### BRIEF DESCRIPTION OF THE DRAWING

A citizen from one country, nation, region, or political boundary may travel abroad to a foreign country with a travel visa (“stamp”) and passport. The Drawing depicts travel to four different continents. At the time of filing this application, there are approximately 196 sovereign states or territories in the world which are recognized as separate countries. Political entities in the world are subject to change in numbers and boundaries. It is contemplated that this use of this invention is effectual for any U.S. born or naturalized citizen. Travel to any country is an intended embodiment of this invention.

### DETAILED DESCRIPTION OF THE DRAWING

FIGURE—1

1. Assignment-Addendum package, A, is a multi-generated custom addendum, in several versions, depending on the Rental Agent's rental contract requirements, and the laws of the country, province, municipality, etc. according to the method and system form generator.

2. In a preferred embodiment the Assignment-Addendum package includes the Administrative Assignment and Claims Assignments with required Addendum language customized for the Rental Agent's contract and country. Other piece meal packages are expected and likely.

3. In a preferred embodiment, the Addendum forms are generated and transmitted in real-time via electronic communication, but in other embodiments the forms are pre-generated in bulk and delivered on hard paper, periodically, to a foreign Rental Agent.

4. In yet other embodiments instructions are given and the Rental Agent generates the Assignment-Addendum package.

5. In a preferred embodiment the Administrative Assignment portion of the Assignment-Addendum package is done once per year or other periodic intervals.

6. In a preferred embodiment, the Claims Assignment portion of the Assignment-Addendum package is custom generated for each Citizen Rental. In yet other embodiments, the Assignment-Addendum package is generated, pre-generated, or copied and mailed to the Rental Agent, piece meal, or in any order or sequence and via any means of sending or transmitting.

7. In a preferred embodiment, the Rental Agent transmits the Citizen signed and executed Addendum and a customized notice (B,C,D,E) via electronic means to the Claims Administrator in the united States as soon as damage is reported or discovered.

### DETAILED DESCRIPTION OF THE INVENTION

a. Long Felt Need

There has been a long felt need in the vehicle rental industry for a mechanism for recovery of damage claims to U.S. citizens who travel to another country. This invention is the subject of a United States patent application, but contemplates travel from or to anywhere in the world. United States law allows for forum selection and choice of law in a contract. Many other countries have laws which also support forum selection and choice of law in a contract.

Current global Economies depend on international contracts, such as when one contracting party is from one country and the other contracting party(ies) is/are from another country. It is not only possible, but quite probable, in today's fast-paced and highly available modes transportation and communication, that parties entering a contract for goods or services will be from different countries. The rental contract produces a unique twist on the international contract. A company based in the United States, for example may have a foreign entity. For example, U.S. companies like Hertz, Avis, or Enterprise are understood to have entities in foreign nations. In this context in the remainder of this application the rental company is referred to as the “Foreign” company and the U.S. Parent (or third party assignee) as the “Parent.”

In situations where the traveler is coming from the United States, very often the reservation for the rental vehicle is made in the United States before the traveler even leaves their home country. This initial negotiation therefore often involves both U.S. travel agents with another U.S. company, but the actual contracting party often turns out to be the U.S. company's Foreign subsidiary. The forum selection clause is an often an overlooked issue as to the rental contract because the vehicle will be both rented and used in the foreign county. But, when damage occurs, very often the person simply returns the car (both during and after hours) to the rental location usually at or adjacent to the international airport and then simply boards the airplane conveniently returning to the United States. The Foreign subsidiary may attempt a “forced charge” to the renter's credit card for the damage, but such charges are easily reversed by the renter and the Foreign rental company has very little recourse in seeking to enforce the foreign signed contract.

Forum selection and choice of law contractual terms are of great importance when a dispute arises between parties and often may be the first items litigated in courts. Forum selection sets the terms for where the litigation will take place and choice of law will set the terms for what substantive law will be followed by the court. This invention addresses specifically international forum selection and choice of law clauses.

b. Local Variations to the Rental Contract/Addendum

In one embodiment, the underlying rental contract might require the renter to enter into a separate contract with the home rental company. In the drawing we use the United States as the example location of the “home” corporation. In consideration for the rental, the foreign rental company or subsidiary will require that an addendum to the rental contract must be signed by the renter which will supersede anything to the contrary in the local rental agreement. This language is prominently identified in the rental contract and brought to the renter's attention. Specifically the addendum states that U.S. Parent or third party assignee (“Parent”) and the renter are the parties to the contract. It is important to note that Parent may include a U.S. Parent Company, third party assignee in the U.S., a local entity in country where the rental takes place, or any combination of one or more entities. In some embodiments the third party assignee may also be preferred depending on Foreign law in the place where the vehicle is rented and the home country of the Parent.

Depending on laws in the Foreign state, the Parent may have to be included on the agreement as a separate signatory. This could present some difficulty if the local rental company has no agency for which to locally sign such an agreement. In this embodiment, there is also a separate “assignment” agreement that takes place between the Parent and the Foreign rental company, which makes the foreign rental company the agent of the U.S. Parent (or third party assignee).

In another embodiment, some countries have social and economic systems which are characterized by government ownership of the means of production. These are sometimes called socialistic, but most of these countries have variant forms of co-operative management economies. Many of these countries have a ministry within the government which must approve any consumer contracts entered into within its territories. Often these local laws only require such approval for contracts with its “citizens.” In other countries the government must in one way or another approve any and all forms of consumer contracts. In such countries, however, the prospect of recovery from non-citizens for damages they cause while in the country are advantageous to its citizens and getting approval for such a contract should not prove to be overly difficult.

Many forms of government for where the local contract is entered are contemplated, including by not limited to dictatorships, socialist states, monarchies, democracies, republics, and others. The law of the “home” country is most important to the enforceability of the contract. The country or state which is the home state of the renter is important to whether or not the country or state allows for forum selection and choice of law. In the United States, the courts have supported both forum selection and choice of law.

c. Elements Common to many Forum Selection and Choice of Law Clauses

Enforceability of forum selection and choice of law clause will often be dependent on each other. Where a contract contains an enforceable forum selection clause, the choice of law clause will normally also be enforced. For example, the Supreme Court of the United States reasoned in M/S Bremen v Zapata Off-Shore Co 407 US 1 (1972). “[w]e cannot have trade and commerce in world markets and international waters exclusively on our terms, governed by our laws and resolved in our courts.” Thus in the preferred embodiment where the “home” country of the traveler is the United States, two key elements are the forum selection and the choice of law clause. One or the other may suffice, but having both clauses is preferred.

The forum selection and choice of law may be included in the rental contract, but in the preferred embodiment, it is a separate addendum only for renters who reside in the home country. U.S. Courts will often differentiate between “required” or “permissive” forum selection and choice of law. A permissive forum clause confers jurisdiction in the forum listed, but does not specifically prohibit party from litigating in another appropriate forum. In this preferred embodiment, the home country is in the United States of America and the clauses are intended to require action be brought in the specified forum. Below is a sample addendum. This is intended to provide an example in a preferred embodiment, but in no way limits this invention to only this form of contract:

A second ingredient in the preferred embodiment is the agency/recovery agreement between the U.S. Parent and the Foreign rental company. This is the agreement that creates the agency for the Foreign rental company to bind the U.S. parent in the agreement between the renter and the U.S. parent company. Note that different laws in different countries may require other rights and responsibilities of parties. Any prosecution or litigation of those rights and responsibilities may sometimes require completely different roles or assignments. This below contractual text is intended to provide an example in a preferred embodiment, but in no way limits this invention to only this form of contract:

1. A method of recovering legal damages to rental property across political boundaries, comprising:
entering into a first damage claim recovery agreement with a first party who resides within a first political boundary
wherein said first party rents goods, property or equipment to a second party, wherein said second party resides within a second political boundary, travels to a location within said first political boundary, rents said goods, property or equipment, and enters into a second damage recovery agreement and agrees to be subject to process within said second political boundary for recovery of damage to said goods property or equipment.

2. The method according to claim one, further comprising;
receiving damage claim information from said first party concerning a damage incident which occurred during the term of a rental of goods, property or equipment to said second party.

3. The method according to claim one, further comprising;
receiving a contingency fee from said first party.

4. The method according to claim one, further comprising;
including terms in said second damage recovery agreement which bind said second party in an agreement with an entity who resides within said second political boundary.

5. The method according to claim one, further comprising;
including terms in said second damage recovery agreement which bind said second party to submit to the jurisdiction of courts within said second political boundary.

6. The method according to claim one, further comprising;
including terms in said second damage recovery agreement which bind said second party to submit to any venue within said second political boundary.

7. The method according to claim one, further comprising;
including terms in said second damage recovery agreement which bind said second party to submit to arbitration in any venue within said second political boundary.

8. A method of paying rental damages concerning rental property across political boundaries, comprising:
traveling from a location within a first political boundary to a location within a second political boundary;
entering into rental agreement with a first party who resides within said second political boundary, for goods, property, or equipment;
wherein said rental agreement includes by terms or addendum a damage recovery clause,
wherein said damage recovery clause binds a second party residing within said first political boundary, with rights or obligations to execute damage recovery within said first political boundary.

9. A method of recovering legal damages to rental property across political boundaries, comprising:
renting goods, property, or equipment to a first party,
wherein said first party resides within a first political boundary and travels to and rents said goods, property, or equipment from a location within a second political boundary;
entering into a first damage claim recovery agreement with said first party,
wherein said first party agrees to allow a second party to process recovery of damage to said goods, property or equipment occurring within said first political boundary;
entering into a second damage claim recovery agreement with said second party agreeing to allow recovery for damage caused to said goods, property, or equipment,
wherein said second party resides within said first political boundary.

10. A system for recovery of legal damages to rental property across political boundaries, comprising:
a first written contract for rental damage claim recovery between a first party who resides within a first political boundary and a second party who resides within a second political boundary and said second party rents goods, property, or equipment to a third party within said second political boundary;
a second written contract with said third party for rental of said goods, property or equipment,
wherein said first party and said third party reside within said first political boundary and said third party agrees to be subject to process for recovery of damage to said goods, property, or equipment within said first political boundary.

11. The system recited in claim 10 wherein said second contract is between said first party and said third party.

12. The system recited in claim 10 wherein said second contract is between said second party and said third party.

13. The system recited in claim 10 wherein said first written contract and said second written contract are included in one combined document.

14. The system recited in claim 10 wherein said second written contract is an addendum to said first written contract.

15. The system recited in claim 10 wherein said first written contract is an addendum to said second written contract.
